(19) United States
(12) Patent Application Publication
(10) Pub. No.: US 2026/0335990 A1
(43) Pub. Date: Oct. 29, 2026

(54) CUTTING TOOL, AND TOOL BODY AND CORE MEMBER FOR THE CUTTING TOOL

(71) Applicant: TUNGALOY CORPORATION, Fukushima (JP)

(72) Inventor: Hiroya SHIKAMA, Fukushima (JP)

(73) Assignee: TUNGALOY CORPORATION, Fukushima (JP)

(21) Appl. No.: 19/660,758

(22) Filed: Apr. 28, 2026

(30) Foreign Application Priority Data
Apr. 28, 2025 (JP) 2025-074274

(51) Int. Cl. B23B 51/04

(52) U.S. Cl. CPC B23B 51/042; B23B 51/0466; B23B 2250/12

(57) ABSTRACT

A core member removably attachable to a tool body of a cutting tool includes: a coolant groove formed in a base end portion of the core member; and a coolant flow path that extends from the coolant groove and communicates through to a leading end portion of the core member. The tool body includes: a core fitting part into which the core member is fitted; a first coolant supply path for supplying coolant from a base end portion side toward the core fitting part; and a second coolant supply path that extends from an inner surface of the core fitting part and communicates through to a leading end portion of the tool body.

### BACKGROUND

### Field

The present invention relates to a cutting tool, and a tool body and a core member for the cutting tool.

### Description of Related Art

Known examples of conventional drilling tools used for making a large diameter hole include a tool configured such that an insert serving as the center cutting edge of the tool is mounted to an insert seat that is integrally formed with the tool head, and a tool in which an insert serving as the center cutting edge is mounted to a pocket provided in the form of a cartridge. Tools having a coolant flow path formed inside the tool are also known for such drilling tools used for making a large diameter hole (see, for example, CN103909287 B, U.S. Pat. No. 9,498,829 B, and DE102017209442 A).

However, in a drilling tool used for making a large diameter hole, the outside diameter of the tool is relatively large compared to the hole size of the coolant flow path disposed near the center axis of the tool body. For this reason, in order to arrange a coolant outlet at a desired location so as to direct coolant from such coolant flow path at the center of the tool body toward a cutting edge at the leading end of the tool, it may be necessary to make intricate branch paths that are separated from the center coolant flow path. As such, drilling tools used for making a large diameter hole tend to have a complicated pattern of flow paths. For example, it may be necessary to make a hole through to the outer surface of the tool so as to allow a flow path to branch off from the center path via such through-hole. In such a case, a further component may be necessary to close the through-hole, despite such further component not being necessary for achieving the functionality as a drilling tool, and such situation is a drawback that needs to be resolved.

### SUMMARY

In view of the above-described circumstances, the present invention specifically relates to a drilling tool used for making a large diameter hole, and an object of the present invention is to provide a cutting tool, and a tool body and a core member for such cutting tool, in which a coolant outlet can be formed at a desired location in a simple manner, without the need to make an intricate flow path as seen in the conventional technology.

In an aspect of the present invention, a core member is provided that is removably attachable to a tool body of a cutting tool, the core member including: a coolant groove formed in a base end portion of the core member along the central axis of the core member; and a coolant flow path that extends from the coolant groove and communicates through to a leading end portion of the core member.

The above-described core member has a structure that enables the supply of coolant from the base end portion to the leading end portion through the coolant flow path, and accordingly, a coolant outlet can be placed at a desired location without the need to make a complicated flow path as seen in the conventional technology.

In the above-described core member, a plurality of coolant grooves may be formed.

In the above-described core member, an inlet of the coolant flow path may be formed on the bottom surface of the coolant groove.

In the above-described core member, a plurality of coolant flow paths may be formed.

In the above-described core member, a pair of coolant flow paths may be formed, which may be two coolant flow paths symmetrical about the central axis.

In the above-described core member, the coolant flow path may include a flow path that extends away from the central axis as it runs from the base end portion to the leading end portion.

In the above-described core member, a helical groove may be formed on the outer surface of the core member.

The above-described core member may be cylindrical in shape.

In the above-described core member, an insert seat may be provided in the leading end portion of the core member for mounting a cutting insert to the insert seat.

In the above-described core member, one or more insert seats may be arranged so as to surround the central axis.

The above-described core member may be a drill.

According to another aspect of the present invention, a tool body of a cutting tool is provided wherein a cutting insert and a drill are removably attachable to the tool body, the tool body including: a core fitting part into which a core member having a cutting edge is fitted along the central axis of the tool body; a first coolant supply path for supplying coolant from a base end portion side toward the core fitting part; and a second coolant supply path that extends from the inner surface of the core fitting part and communicates through to a leading end portion of the tool body.

In the above-described tool body, a plurality of second coolant supply paths may be formed.

In the above-described tool body, a pair of second coolant supply paths may be formed, which may be two coolant supply paths symmetrical about the central axis.

In the above-described tool body, the second coolant supply path may include a flow path that extends away from the central axis as it runs from the base end portion to the leading end portion.

In the above-described tool body, a helical groove may be formed on the outer surface of the tool body.

In the above-described tool body, a coolant outlet may be arranged forward of the helical groove in a direction of rotation of the tool body.

According to a further aspect of the present invention, a cutting tool having a core member and a tool body as described above is provided, wherein the second coolant supply path is formed so as to communicate with the coolant groove of the core member in a state where the core member is fitted into the core fitting part of the tool body in a predetermined orientation.

### BRIEF DESCRIPTION OF DRAWINGS

FIG. 1 is a perspective view illustrating a cutting tool according to an embodiment of the present invention.

FIG. 2 is a perspective view illustrating an example of a drill head (tool body) of a cutting tool.

FIG. 3 is a perspective view illustrating an example of a core member that is removably attachable to a drill head.

FIG. 4A is an exploded perspective view illustrating a drill head, a core member, a cutting insert, and others.

FIG. 4B is a perspective view illustrating a cutting insert.

FIG. 5 illustrates a drill head and other members as viewed from the leading end side.

FIG. 6A is a sectional view of the drill head and other members in FIG. 5, cut along the line VI-VI in FIG. 5.

FIG. 6B is an enlarged partial view of FIG. 6A.

FIG. 7 is a perspective view illustrating an example of a core member.

FIG. 8 illustrates a core member as viewed from the leading end side of the core member.

FIG. 9 illustrates a core member as viewed from the side surface of the core member.

FIG. 10 is a sectional view of the drill head and the core member in FIG. 5, cut along the line X-X in FIG. 5.

FIG. 11 is a sectional view of the drill head and the core member in FIG. 5, cut along the line XI-XI in FIG. 5.

FIG. 12 is a perspective view of a drill head and a core member, with a cross-section as shown in FIG. 10.

FIG. 13A is a perspective view of a core member as viewed from the leading end side of the core member, with a center cutting edge (cutting insert) being mounted to an insert seat.

FIG. 13B is a perspective view of a core member as viewed from the base end side of the core member.

### DETAILED DESCRIPTION

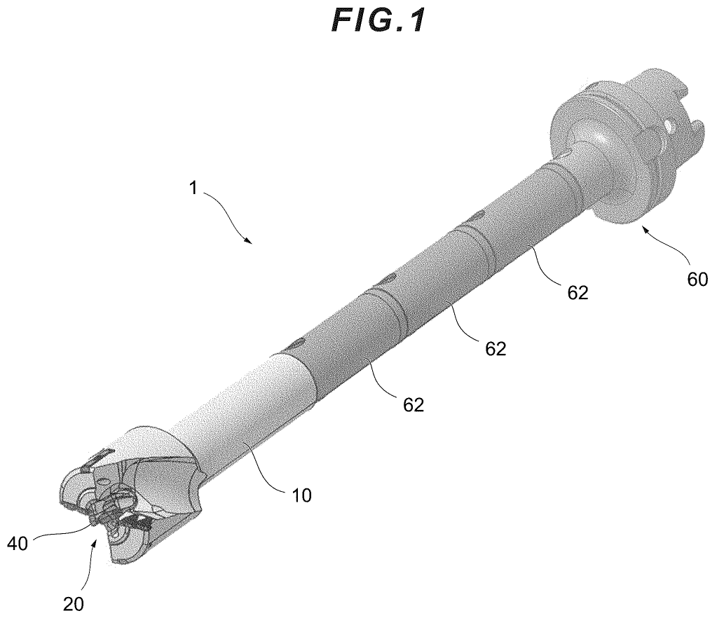

Preferred embodiments of a cutting tool, and a tool body and a core member for such cutting tool, according to the present invention, will now be described in detail, with reference to the attached drawings (see FIG. 1, etc.).

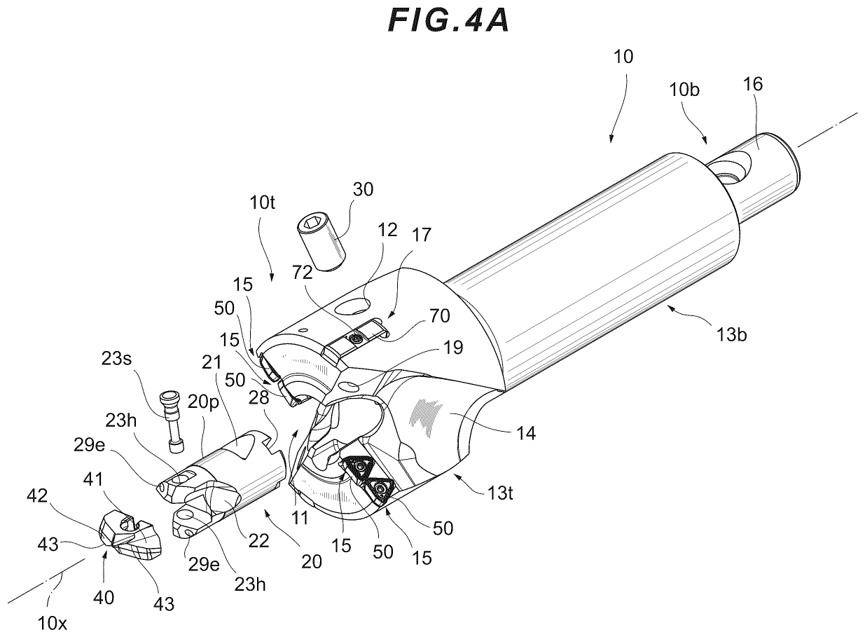

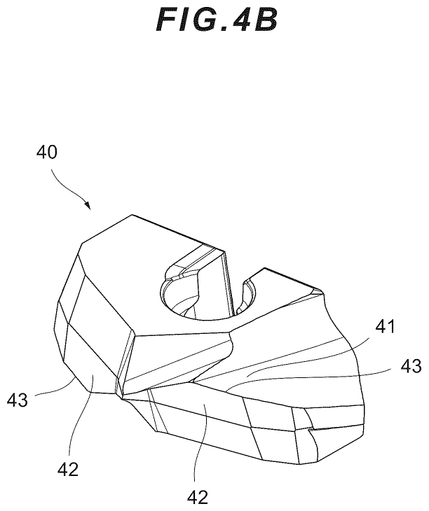

As an example of preferred embodiments of the present invention, a drilling tool 1 will be described below (see FIG. 1, etc.). The drilling tool 1 of the present embodiment is configured as a tool which may have, e.g., a tool body 10, a core member 20 removably attachable to the tool body 10, and a fastening device 30 (see FIG. 4A, etc.).

### Tool Body

The tool body 10 is formed as a member which is configured so that a cutting insert 50 and a drill can be removably mounted/attached to the tool body, and it functions as a drill head when the cutting tool is configured as a drilling tool 1 as in the present embodiment. The tool body 10 of this embodiment is shaped so that it extends from the base end portion 10b to the leading end portion 10t along the central axis 10x. The tool body 10 may include, for example, a core fitting part 11, a through-hole 12, an outer surface 13, a chip discharge groove 14, an insert seat 15, an extension connecting part 16, a guide pad mounting part 17, and a coolant supply path 18 (see FIG. 4A, etc.).

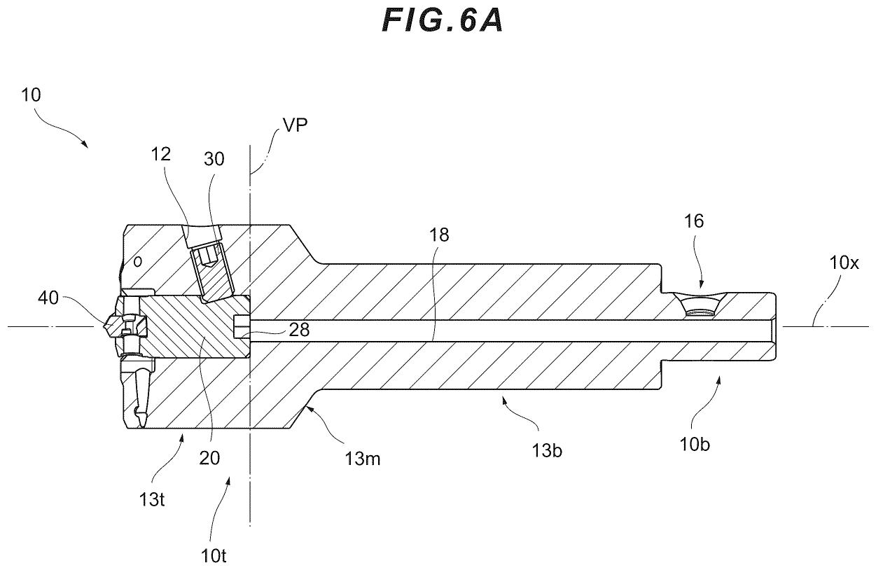

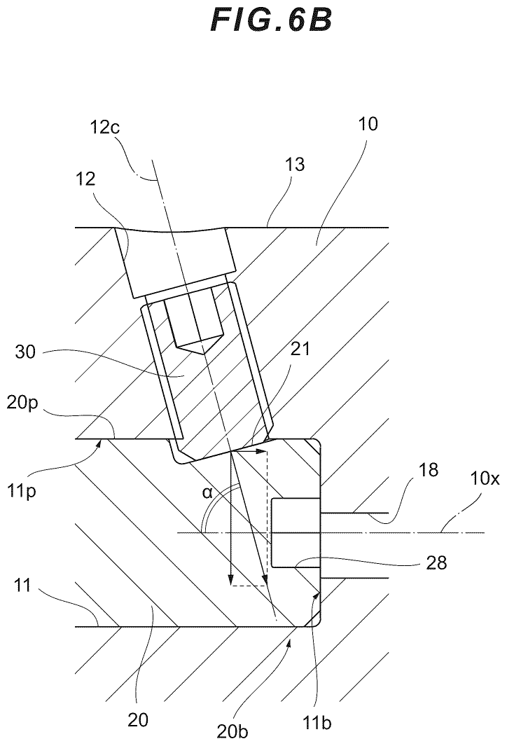

The core fitting part 11 is provided at the leading end portion 10t of the tool body 10 so that the core member 20 is fitted therein along the central axis 10x. The core fitting part 11 is formed so as to agree with the outer shape of the core member 20. For example, according to the cylindrical shape of the core member 20, the core fitting part 11 may be shaped in a circular hole, having an inner surface 11p formed along the central axis 10x, and a bottom surface 11b which comes into contact with a base end portion 20b of the core member 20 (see FIG. 6A, etc.). The core member 20 fitted into the core fitting part 11 is fastened to the tool body 10 with the fastening device 30 (see FIG. 6A, etc.).

The through-hole 12 is provided as a hole for setting the fastening device 30, such as by allowing the fastening device 30 to pass through the hole. The through-hole 12 may have a variety of forms according to specific examples of the fastening device 30. For example, in the present embodiment, a fastening screw is used for the fastening device 30, and the through-hole 12 therefore has an internal thread formed on its inner surface so as to engage with the fastening screw (see FIG. 4A, etc.). Further, in the present embodiment, the center line 12c of the through-hole 12 is angled relative to the central axis 10x, and the through-hole 12 is inclined toward the leading end portion 10t of the tool body 10 as it extends radially outward of the tool body 10. The through-hole 12 is further configured such that it extends from the outer surface 13 of the tool body 10 through to the inner surface 11p of the core fitting part 11 (see FIG. 6A, etc.). When the fastening device 30 is passed through such angled through-hole 12 and presses a contact surface 21 formed on the outer surface of the core member 20, a component of force will act on the core member 20 in a direction along the central axis 10x, as well as a force acting in the radial direction. With this configuration, the fastening device 30 can apply not only the force that presses the core member 20 against the inner surface 11p, but can also apply the force that presses the core member 20 along the central axis 10x against the bottom surface 11b of the core fitting part 11, and as a consequence, the fastening device 30 can achieve stronger and more rigid fastening and holding of the core member 20 by axially pushing the core member 20 toward the base end portion 10b and thrusting it against the bottom surface 11b (see FIG. 6B, etc.). The angle α formed between the central axis 10x of the tool body 10 and the center line 12c of the through-hole 12 is not particularly limited, as long as the above-described structure is realized. From the perspective of obtaining the above-mentioned functionality, such angle α is preferably 45 degrees or more and less than 90 degrees, and more preferably 74 degrees or more and 76 degrees or less, on a virtual plane defined by the central axis 10x and the center line 12c. Additionally, such angle α formed between the central axis 10x of the tool body 10 and the center line 12c of the through-hole 12 may be the same as the angle formed by the central axis 10x and a perpendicular line 21v to the contact surface 21, on a virtual plane defined by the central axis 10x and the center line 21v.

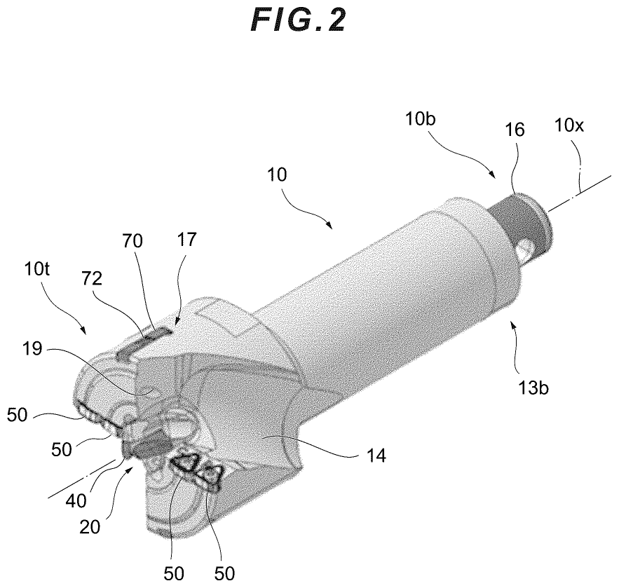

The outer surface 13 of the tool body 10 includes a large-diameter part 13t which is closer to the leading end portion 10t, a small-diameter part 13b which is closer to the base end portion 10b, and a tapered part 13m which connects between the large-diameter part 13t and the small-diameter part 13b (see FIG. 2, etc.). The through-hole 12 is opened on the surface of the large-diameter part 13t (see FIGS. 6A and 6B).

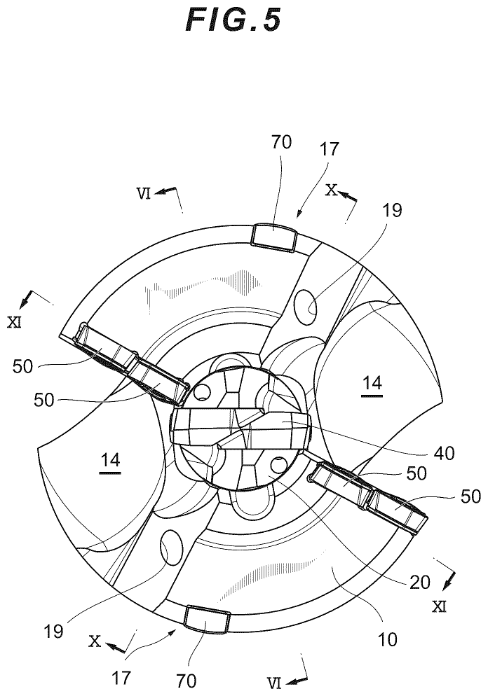

The chip discharge groove 14 is a groove for allowing chips generated during cutting to be removed together with coolant. The tool body 10 of this embodiment has a pair of helical chip discharge grooves 14 formed on the outer surface 13, and such two grooves 14 are axially symmetrical around the central axis 10x (see FIG. 5, etc.).

The insert seat 15 is provided as a seat for mounting a cutting insert 50 to the tool body 10. The specific form of such insert seat 15 and the specific form of the cutting insert 50 mounted thereon are not particularly limited. A plurality of insert seats 15 may be provided radially outward of the core fitting part 11. As an example, in the present embodiment, a total of four insert seats 15 are arranged diametrically in a line, with two of them on each side with respect to the central axis 10x (see FIG. 5, etc.). A cutting insert 50 is mounted on each of the insert seats 15 in a predetermined orientation (see FIG. 2, etc.).

The extension connecting part 16 serves as a portion for connecting an extension 62 to the tool body 10 (see FIGS. 1 and 2, etc.). Although not shown in the drawings, an adapter 60 may be directly attached to the extension connecting part 16, without having an extension 62.

The guide pad mounting part 17 is a portion provided for mounting a guide pad 70. The guide pad 70 is a member that serves as a guide while a workpiece is being cut by a cutting insert 50, etc., by way of making contact with the inner wall of a hole created in the workpiece through cutting. The guide pad 70 is mounted to the guide pad mounting part 17 and fastened and affixed to a side (outer surface 13) of the tool body 10 with a fastening screw 72 (see FIG. 2, etc.).

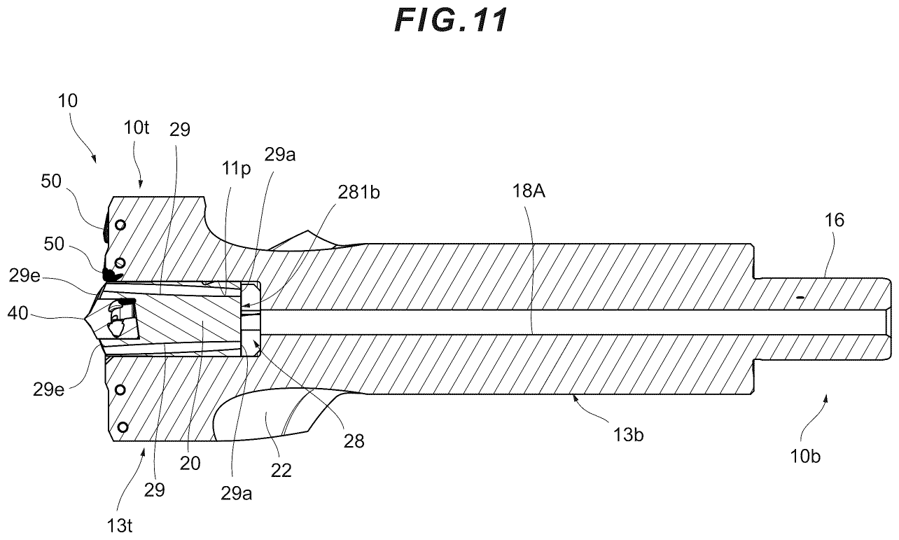

The coolant supply path 18 is a flow path provided for supplying coolant to a cutting edge located at the leading end of the drilling tool 1 (e.g., a cutting edge of a cutting insert 40 forming the center cutting edge). In the tool body 10 of the present embodiment, a first coolant supply path 18A having a circular cross-section is formed inside the tool body 10, so as to extend straight along the central axis 10x from the base end portion 10b toward the leading end portion 10t (see FIGS. 6A, 6B and 11). The leading end portion 10t side of the first coolant supply path 18A is open on the bottom surface 11b of the core fitting part 11, from which coolant is supplied toward a coolant groove 28 of the core member 20.

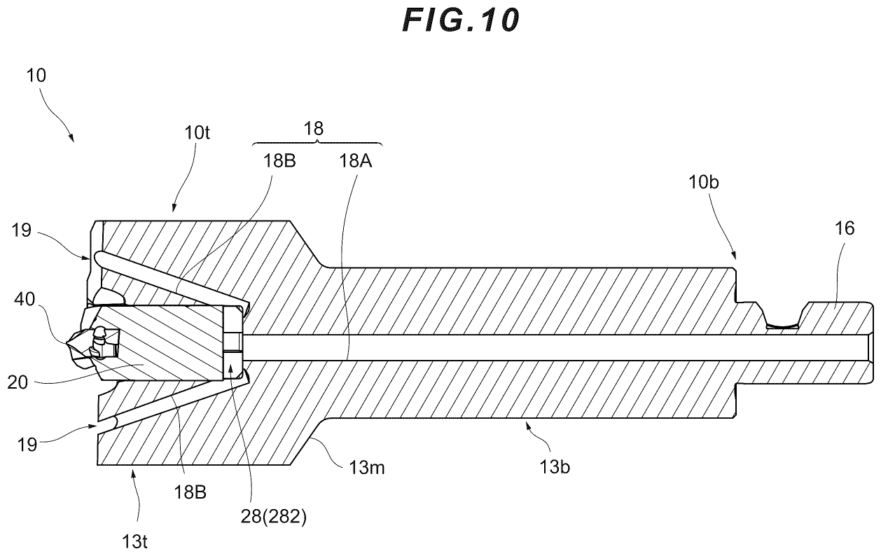

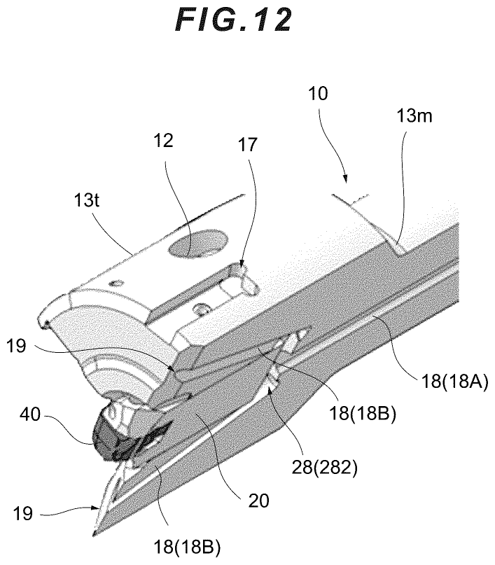

The tool body 10 further includes a second coolant supply path 18B and a coolant outlet 19 (see FIG. 10). The second coolant supply path 18B is formed so that it extends from the inner surface 11p of the core fitting part 11 of the tool body 10 and communicates through to the leading end portion 10t of the tool body 10, and the specific details of such second coolant supply path 18B are not particularly limited. As an example, in the tool body 10 of the present embodiment, two second coolant supply paths 18B are formed in a pair and arranged symmetrically about the central axis 10x (see FIGS. 10 and 12). Further, each of the two second coolant supply paths 18B extends away from the central axis 10x as it runs from the base end portion 10b to the leading end portion 10t of the tool body 10, such as in a diverging configuration (see FIGS. 10 and 12). In such case, a centrifugal force acting upon the rotation of the tool body 10 can also be utilized as a force for delivering coolant toward the leading end portion 10t.

The coolant outlet 19 serves as a discharge port from which coolant flowing through the coolant supply path 18 (the first and second coolant supply paths 18A and 18B) is output. In the tool body 10 of this embodiment, such coolant outlet 19 is provided for each of the two second coolant supply paths 18B, at a location forward of the chip discharge groove (helical groove) 14 in the direction of rotation of the tool body 10 (see FIGS. 4A and 5). When coolant is output from the coolant outlet 19 arranged in the above-described manner, it facilitates the delivery of chips toward the chip discharge groove (helical groove) 14 for removal of the chips.

### Core Member

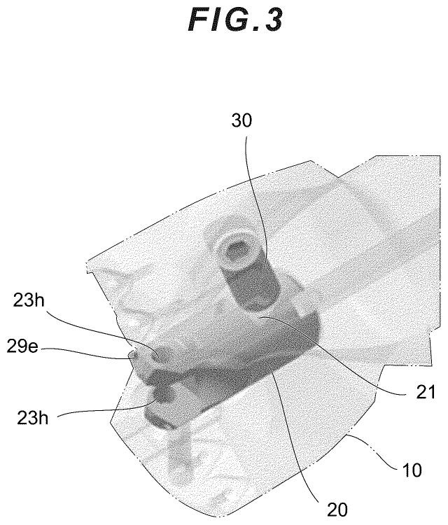

The core member 20 is a steel member (steel body) that is removably attachable to the core fitting part 11 of the above-described tool body 10 (see FIGS. 3-9). Examples of the core member 20 may include a member having an integrated cutting edge at a leading end thereof, which is often called a “solid drill,” as well as an indexable member and a head-replaceable member. By way of example, the present embodiment describes a core member 20 having a head-replaceable configuration. The core member 20 of the present embodiment is in a substantially cylindrical shape (including a hollow cylinder) and extends along the central axis 20x. The core member 20 may include, for example, a contact surface 21, a helical groove 22, an insert seat 23, a coolant groove 28, and a coolant flow path 29.

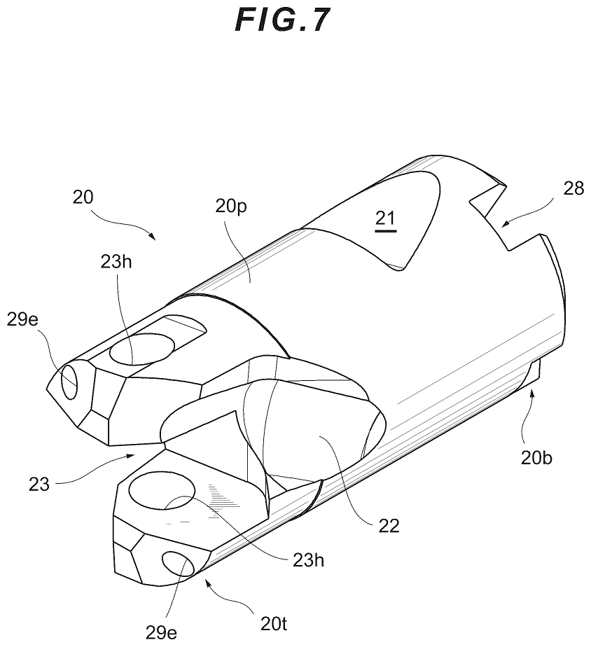

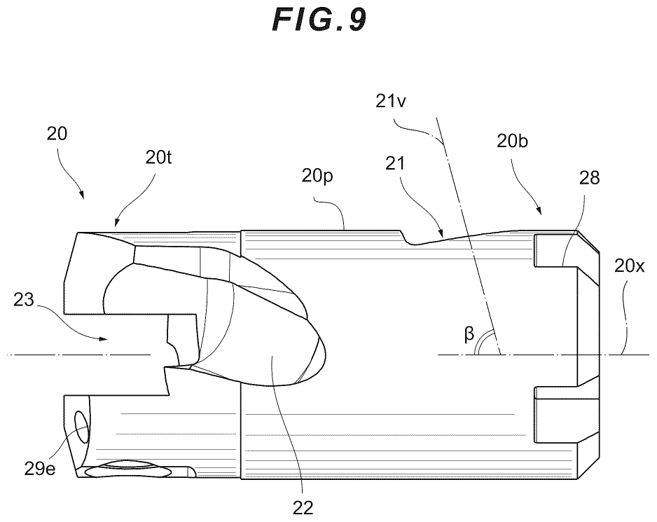

The contact surface 21 is formed as a surface which comes into contact with a portion of the fastening device 30. In the present embodiment, a portion of the outer surface 20p of the core member 20 is cut, and the contact surface 21 is formed in such cut portion (see FIG. 7, etc.). The core member 20 is fitted into the core fitting part 11 along the central axis 10x of the tool body 10 and, in this state, a portion of the fastening device 30 is brought into contact with the contact surface 21, thereby fastening the core member 20 to the tool body 10 (see FIG. 3, etc.). The contact surface 21 is inclined relative to a virtual plane (as indicated by the letters VP in FIG. 6A) which is perpendicular to the central axis 20x of the core member 20, and such contact surface 21 faces outward toward the leading end portion 20t of the core member 20 (see FIG. 9, etc.). The contact surface 21 is desirably configured so that the angle β formed by the central axis 20x of the core member 20 and the perpendicular line 21v to the contact surface 21 is 45 degrees or more and less than 90 degrees on a virtual plane defined by the central axis 20x and the perpendicular line 21v (for such virtual plane, please see the cross-section as illustrated in FIG. 6B, and also see FIG. 9). An example of the preferable range of the angle β may be 74 degrees or more and 76 degrees or less.

In the present embodiment, the above-described contact surface 21 is formed at a location close to the base end portion 20b of the core member 20 (see FIG. 7, etc.). However, this is merely an example, and the contact surface 21 may conversely be formed at a location close to the leading end portion 20t. Alternatively, the contact surface 21 may be formed around the longitudinally middle section along the central axis 20x. The contact surface 21 in the present embodiment is a flat surface (see FIG. 9, etc.); however, the contact surface 21 may be, for example, a surface which is at least partly curved. Although not shown in the drawings, the contact surface 21 may be formed, for example, as a concave surface, and a portion of the fastening device 30 (i.e., a portion that is brought into contact with the contact surface 21) may be formed so as to be a convex surface that mates with the concave surface, so that the feature of autonomous position alignment or center adjustment can be attained when the fastening device 30 is pressed against the contact surface 21. Although not shown in the drawings, a converse structure may also be used, i.e., the contact surface 21 may be configured as a convex surface and a portion of the fastening device 30 (i.e., a portion that is brought into contact with the contact surface 21) may be formed as a concave surface that mates with the convex surface. Alternatively, the contact surface 21 may be configured as a convex surface, while a portion of the fastening device 30 (i.e., a portion that is brought into contact with the contact surface 21) may be a flat surface. In the latter case, the contact position between the fastening device 30 and the contact surface 21 is less likely to be affected by manufacturing tolerance, and the core member 20 can be fastened at a position as designed with a high degree of accuracy.

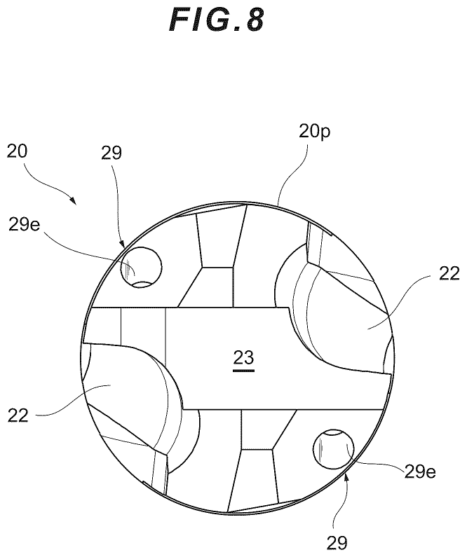

The helical groove 22 is a groove formed in a helical shape on the outer surface of the core member 20. The core member 20 of the present embodiment has a pair of helical grooves 22 on the outer surface 20p, and such two grooves 22 are axially symmetrical around the central axis 20x (see FIG. 8, etc.). Further, the helical groove 22 is formed so as to smoothly join to, or to generate a smoothly connecting surface with, the chip discharge groove 14 of the tool body 10, when the core member 20 is fitted in the core fitting part 11 (see FIG. 2, etc.). With this configuration, along with the form of the chip discharge groove 14 having no steps therein, there will not be any obstacle when removing chips, thereby leading to enhanced chip discharge capability.

The insert seat 23 is provided at the leading end portion 20t of the core member 20 such that a cutting insert 40 is mounted on the insert seat 23 along the central axis 20x (see FIG. 4A, etc.). A screw hole 23h is formed near the insert seat 23 so that a fastening screw 23s for fastening the cutting insert 40 is inserted through the hole 23h. The cutting insert 40 that is mounted on the insert seat 23 along the central axis 20x as described above functions as the center cutting edge of the drilling tool 1. It should be noted that a rake surface 41 and a flank 42 are formed at the leading end side of such cutting insert 40 serving as the center cutting edge of the drilling tool 1, and a cutting edge 43 is formed at the intersecting edge between the rake surface 41 and the flank 42, wherein the rake surface 41 faces forward in the tool rotating direction, and the flank 42 faces in the direction of the central axis 10x and extends away from the leading end as it goes rearward in the tool rotating direction (see FIGS. 4A and 4B). The example described herein explains the configuration that has a single insert seat 23 at a position corresponding to the center of the drilling tool 1; however, other configurations may also be employed. For example, although not shown in the drawings, a plurality of insert seats 23 may be arranged around the central axis 20x and an indexable insert may be mounted to such insert seats 23 so as to use the tool as an indexable drill.

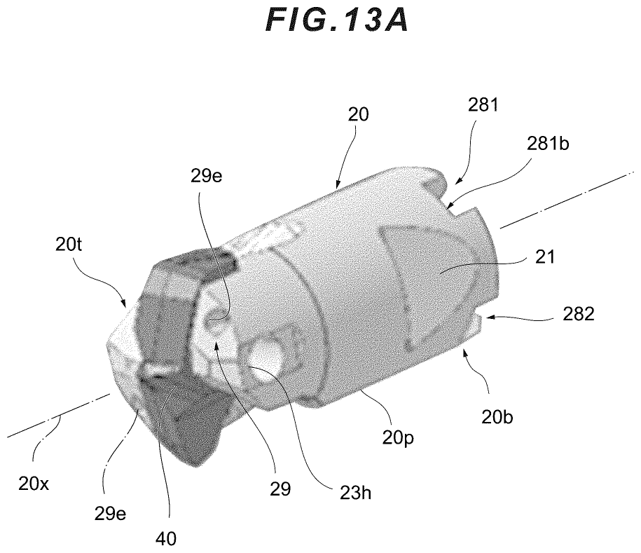

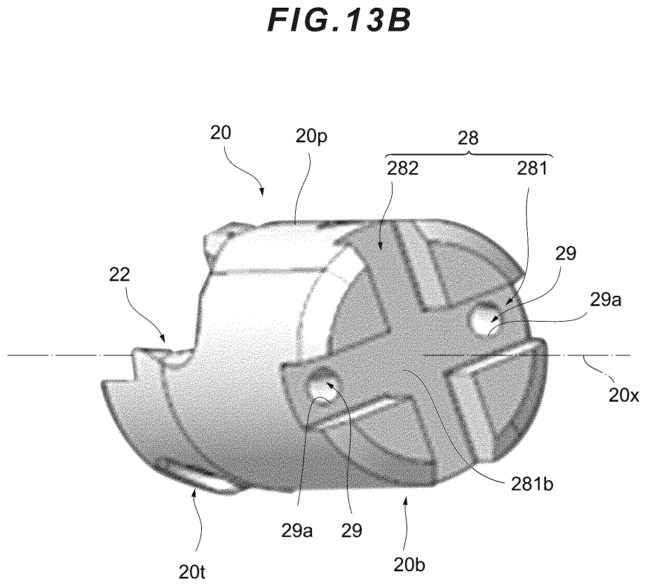

The coolant groove 28 is formed in the base end portion 20b of the core member 20. When the core member 20 is fitted in the core fitting part 11 of the tool body 10, the coolant groove 28 communicates with the coolant supply path 18 of the tool body 10, forming a flow path through which coolant flows (see FIG. 6A, etc.). The shape and structure of the coolant groove 28 are not particularly limited. For example, it may be a single groove, or may be formed of a plurality of grooves. In the core member 20 of the present embodiment, the coolant groove 28 is formed of two grooves, i.e., first and second coolant grooves 281 and 282 that intersect in the shape of a cross (see FIGS. 7 and 13B, etc.). An inlet 29a of the coolant flow path 29 is formed on the bottom surface 281b of the first coolant groove 281. In the core member 20 of the present embodiment, two inlets 29a are formed symmetrically about the central axis 20x (see FIGS. 11 and 13B).

The coolant flow path 29 is a flow path formed inside the core member 20 and may include, for example, a plurality of such flow paths. The coolant flow path 29 directs the coolant flowing into the coolant groove 28 toward the leading end portion 20t so as to output the coolant there. In the core member 20 of the present embodiment, the coolant flow path 29 is comprised of two flow paths, each running from a portion of the coolant groove 28 (e.g., the bottom surface 281b of the first coolant groove 281) through to the coolant outlet 29e (see FIGS. 7, 8 and 12, etc.). Such two coolant outlets 29e forming a pair are arranged in a manner such that coolant is output toward the cutting edge at the leading end of the drilling tool 1 (e.g., the cutting edge of the cutting insert 40 serving as the center cutting edge) (see FIG. 13A, etc.). The two coolant flow paths 29 in the core member 20 of the present embodiment are formed symmetrically about the central axis 20x (see FIG. 11, etc.). Further, these coolant flow paths 29 are configured so as to extend gradually away from the central axis 20x as it runs from the base end portion 20b to the leading end portion 20t, such as in a diverging configuration (see FIG. 11).

Since the core member 20 of the present embodiment has the structure as described above, it is able to supply coolant from the base end portion 20b to the leading end portion 20t through the coolant flow path 29 as described above. Accordingly, the core member 20 allows a coolant outlet 29e to be arranged at a desired position, without the need to form a complicated flow path as seen in the conventional technology.

### Fastening Device

The fastening device 30 is used to fasten the core member 20 fitted in the core fitting part 11 of the tool body 10. As described above, a fastening screw is used for the fastening device 30 in the present embodiment (see FIG. 6A, etc.), but this is merely an example of suitable means for fastening the core member 20 and it will obviously be appreciated that other members may also be used instead of a screw. Examples of members that can be used other than a screw may include a biasing member that uses elastic deformation (such as a spring member or a member obtained by deforming a portion of the tool body 10). Further, the configuration of the through-hole 12 may be modified as appropriate according to the configuration of the fastening device 30 (for example, a biasing member may be received in a bottomed hole, rather than a through-hole).

### Drilling Tool

The drilling tool 1 of the present embodiment is configured as a tool that comprises, for example, a tool body 10, a core member 20 removably attachable to the tool body 10, and a fastening device 30 as described above (see FIG. 4A, etc.). When the core member 20 is fitted in the core fitting part 11 of the tool body 10 in a predetermined orientation and fastened by the fastening device 30 (see FIG. 6A, etc.), the second coolant supply path 18B communicates with the second coolant groove 282 of the coolant groove 28 of the core member 20 (see FIG. 10). Part of the coolant that has been supplied from through the first coolant supply path 18A flows into the second coolant supply path 18B via the coolant groove 28 of the core member 20 and is then output from the coolant outlet 19.

According to the above-described tool body 10, core member 20 and fastening device 30, and the drilling tool 1 constituted by these elements, the fastening device 30 presses the contact surface 21 of the core member 20 in an angled direction relative to a virtual plane VP which is perpendicular to the central axis 20x of the core member 20. Such pressing generates a component of force acting in a direction along the central axis 10x of the tool body 10, or the central axis 20x of the core member 20, thereby allowing the core member 20 to be more firmly and rigidly fastened to the tool body 10. Some conventional drilling tools for making large-diameter holes employ a cartridge-type insert seat for mounting an insert serving as a center cutting edge of the tool, and this configuration can be said to be advantageous compared to tools which do not employ such cartridges, since it allows for an insert seat for the center cutting edge to be selectively replaced if the insert seat is damaged or broken. However, in some cartridge-type drilling tools, a cylindrical component that serves as the center cutting edge may be fastened by the following steps: (i) inserting the component into an insertion hole provided in the center of the drilling tool body at the leading end in the axial direction; (ii) inserting a screw into a screw hole that is provided perpendicular to the central axis of the tool body and extends from the outer surface of the tool body through to the inner surface of the insertion hole; and (iii) using the leading end of such inserted screw to press a flat face of the component, which is formed on the side surface of the component parallel to the central axis of the component. In this fastening method, if force is applied in a direction parallel to the central axis of the component, the tool will have to endure such parallel force with only a frictional force occurring between the inner surface of the insertion hole and the outer surface of the component due to the pressing force applied by the screw. In contrast, the drilling tool 1 according to the present embodiment is advantageous in this respect, as has already been described above.

Furthermore, the drilling tool 1 of the present embodiment employs a configuration which can be called a two-tier structure in which a replaceable center cutting edge (cutting insert 40) is fitted to the core member 20, and such core member 20 is further fitted to the tool body 10. This configuration helps to prevent the breakage or deformation of the tool body 10 itself, also allows the core member 20 to be firmly and rigidly fastened to the tool body 10, and accordingly facilitates the exertion of stable cutting performance even in machining under highly-efficient conditions or in an unstable state.

The above-described embodiment is an example of a preferred mode of implementation of the present invention; however, the present invention is not limited to the described embodiment and may be modified in various ways without departing from the spirit of the present invention. For example, the drilling tool 1 described in the above embodiment is configured such that the core member 20 is removably attachable to the tool body (drill head) 10 and the center cutting edge (cutting insert 40) is also removable from the core member 20 (i.e., it is a two-tier, indexable cutting tool); however, this is only an example of a preferred configuration, and it will obviously be appreciated that the present invention may also be applied to tools with other structures, such as a brazed-type tool having a brazed tip of cemented carbide, etc. (e.g., a brazed drill or a core member 20, having a cutting edge which is a brazed tip made of cemented carbide or other material for such drill).

The above-described embodiment explains an example in which the present invention is applied to a drilling tool 1; however, this is merely an example of a cutting tool to which the present invention can be applied. In addition to such drilling tools (drills), the present invention may also be applied to, for example, milling tools such as an end mill.

Although the description above has been made by referring to an example of a two-tier-structure cutting tool (drilling tool) as described above, the present invention can obviously also be applied to a cutting tool with a three-tier structure. For example, the core member 20 may be a solid drill in which a drill serving as the center cutting edge is integrally formed at the leading end portion 20t, with one or more cutting inserts arranged in the periphery of the drill (i.e., outward of the center cutting edge), and such core member 20 may further be combined with to the tool body 10. The present invention may also be applied to such three-tier-structure cutting tools.

The present invention is suited for use in a cutting tool, and a tool body and a core member for such cutting tool.

What is claimed is:

1. A core member removably attachable to a tool body of a cutting tool, the core member comprising:
a coolant groove formed in a base end portion of the core member along a central axis of the core member; and
a coolant flow path that extends from the coolant groove and communicates through to a leading end portion of the core member.

2. The core member according to claim 1, comprising a plurality of the coolant grooves.

3. The core member according to claim 1, wherein an inlet of the coolant flow path is formed on a bottom surface of the coolant groove.

4. The core member according to claim 1, comprising a plurality of the coolant flow paths.

5. The core member according to claim 4, wherein the coolant flow paths include a pair of coolant flow paths which are symmetrical about the central axis.

6. The core member according to claim 4, wherein each of the coolant flow paths is configured as a flow path that extends away from the central axis as the flow path runs from the base end portion to the leading end portion.

7. The core member according to claim 1, comprising a helical groove formed on an outer surface of the core member.

8. The core member according to claim 1, wherein the core member is cylindrical in shape.

9. The core member according to claim 1, comprising one or more insert seats provided in the leading end portion of the core member for mounting a cutting insert to the insert seat.

10. A tool body of a cutting tool, wherein a cutting insert and a drill are removably attachable to the tool body, the tool body comprising:
a core fitting part into which a core member having a cutting edge is fitted along a central axis of the tool body;
a first coolant supply path for supplying coolant from a base end portion side toward the core fitting part; and
a second coolant supply path that extends from an inner surface of the core fitting part and communicates through to a coolant outlet in a leading end portion of the tool body.

11. The tool body according to claim 10, comprising a plurality of the second coolant supply paths.

12. The tool body according to claim 11, wherein the second coolant supply paths include a pair of second coolant supply paths which are symmetrical about the central axis.

13. The tool body according to claim 11, wherein each of the second coolant supply paths is configured as a flow path that extends away from the central axis as the flow path runs from the base end portion to the leading end portion.

14. The tool body according to claim 10, comprising a helical groove formed on an outer surface of the tool body.

15. The tool body according to claim 14, wherein the coolant outlet is disposed at a position forward of the helical groove in a direction of rotation of the tool body.

16. A cutting tool comprising a core member and a tool body,
the core member being removably attachable to the tool body of the cutting tool, the core member comprising:
a coolant groove formed in a base end portion of the core member along a central axis of the core member; and
a coolant flow path that extends from the coolant groove and communicates through a leading end portion of the core member,
wherein a cutting insert and a drill are removably attachable to the tool body, and the tool body comprises:
a core fitting part into which the core member having a cutting edge is fitted along a central axis of the tool body;
a first coolant supply path configured to supply coolant from a base end portion side toward the core fitting part; and
a second coolant supply path that extends from an inner surface of the core fitting part and communicates through to a coolant outlet in a leading end portion of the tool body,
wherein the second coolant supply path is formed so as to communicate with the coolant groove of the core member in a state where the core member is fitted into the core fitting part of the tool body in a predetermined orientation.
